(19) United States
(12) Patent Application Publication
(10) Pub. No.: US 2025/0281892 A1
(43) Pub. Date: Sep. 11, 2025

(54) Photoreactor Design for Chemical Reactions with Limited Thermodynamics

(71) Applicant: Syzygy Plasmonics Inc., Houston, TX (US)

(72) Inventors: Hossein Robatjazi, Houston, TX (US); Suman Khatiwada, Houston, TX (US)

(73) Assignee: Syzygy Plasmonics Inc., Houston, TX (US)

(21) Appl. No.: 18/862,665

(22) PCT Filed: May 4, 2023
(86) PCT No.: PCT/US2023/020999

§ 371 Date: Nov. 4, 2024

Related U.S. Application Data
(60) Provisional application No. 63/338,378, filed on May 4, 2022.

(51) Int. Cl. B01J 8/02; B01J 8/00; C01C 1/04

(52) U.S. Cl. CPC B01J 8/025; B01J 8/001; B01J 8/0278; B01J 8/0285; C01C 1/0417; B01J 2208/00061; B01J 2208/00176; B01J 2208/00398; B01J 2208/00415; B01J 2208/00884

(57) ABSTRACT

Disclosed herein is a photoreactor design having an optically accessible reactor chamber with a short gas flow residence time for carrying out gas-phase catalytic reactions under light illumination. A vertically arranged reactor is provided with a lighting source, a horizontally arranged thin catalyst bed layer supported on a gas-permeable bounding plate through which gas is passed in the vertical direction, and in which incident photons from the light source are perpendicular to the horizontally arranged thin catalyst bed layer. The described technology is intended to enable a number of industrially relevant chemical reactions to proceed under light illumination on the surface of metal photocatalysts with efficiencies and selectivity beyond that dictated by thermodynamic equilibrium in conventional thermal catalysis in the heat-powered plants.

### FIELD

This disclosure relates to the field of industrial chemical production using photocatalytic reactors and, in particular, to a photoreactor design for chemical reactions with limited thermodynamics.

### BACKGROUND

Traditional systems for heat-driven heterogeneous catalysis in gas-phase on supported metal nanoparticles (NPs) are limited in their efficiency by thermal equilibrium and a linear energy-dependency of elementary steps that controls the overall reactivity. Typical thermocatalytic gas-phase reactors are characterized by an axially-oriented catalyst bed integrated into a cylindrical reactor made of high-alloy steel, with a catalyst bed height-to-diameter ratio of typically much larger than one (>1), resulting in a relatively long residence time (average time spent by a gas-phase reactant molecule in a reactor chamber).

Reducing residence time (i.e., minimizing the contact time between the reactants and catalyst) has been thought to increase productivity in certain reactions. Thus, some recent reactor designs, primarily utilizing fluidized catalyst beds, have attempted to reduce residence time. Examples of such designs are set forth in U.S. Pat. Nos. 5,605,551, 5,240,592, and 5,110,452, as well as in EP Published Patent Application No. 0485378A1. However, like typical cylindrical thermocatalytic reactors, each of the aforementioned reactors is also heat-driven and thus still suffers from efficiency limitations resulting from thermal equilibrium and a linear energy-dependency of elementary steps that controls the overall reactivity.

Photocatalysis using optically-active metal catalysts under photon illumination in the ultraviolet-to-visible-light spectrum has shown improved energy efficiency over conventional thermocatalysis. By combining photon-induced electronic and thermal effects, photocatalysis promotes reaction rates beyond those of purely thermal catalysis and opens reactivity channels that are inaccessible by thermal-only means. Coupling light to the reaction pathway provides a non-thermal (electronic) energy transfer that accelerates dissociation and desorption events through inducing vibronic and electronic excitations to the surface adsorbates. These surface adsorbates, as reaction intermediates, are promoted to a new potential energy surface in the excited state with a lower energy barrier. Thus, energy requirements are reduced over conventional thermocatalysis. Conventional thermocatalytic reactor designs are inadequate for photocatalysis. Therefore, an improved photocatalytic reactor design is desirable.

### BRIEF DESCRIPTION OF THE DRAWINGS

The accompanying drawings are included to provide a further understanding of the systems, apparatus, devices, and/or methods of the disclosure, and are incorporated in and constitute a part of this specification. The drawings are not necessarily to scale, and sizes of various elements may be distorted for clarity and/or illustrated as simplistic representations to promote comprehension. The drawings illustrate one or more embodiments of the disclosure, and together with the description, serve to explain the principles and operation of the disclosure.

FIG. 1A is a simplified longitudinal sectional diagram illustrating a vertically arranged photoreactor, according to a first example cylindrical embodiment.

FIG. 1B is a simplified top view of the first example cylindrical embodiment of the photoreactor illustrated in FIG. 1A.

FIG. 1C is a simplified top view of an example rectangular variation of the photoreactor illustrated in FIG. 1A.

FIG. 1D is a simplified top view of an example hexagonal variation of the photoreactor illustrated in FIG. 1A.

FIG. 2 is a graphical diagram illustrating experimental results of photocatalytic ammonia synthesis using a photoreactor in accordance with the first example embodiment.

FIG. 3 is a graphical diagram illustrating thermodynamic equilibrium of ammonia synthesis according to Haber, 1920.

### DETAILED DESCRIPTION

Example systems, apparatus, devices, and/or methods are described herein. It should be understood that the word “example” is used to mean “serving as an example, instance, or illustration.” Any embodiment or feature described herein as being an “example” is not necessarily to be construed as preferred or advantageous over other embodiments or features unless stated as such. Thus, other embodiments can be utilized, and other changes can be made, without departing from the scope of the subject matter presented herein. The aspects described herein are not limited to specific embodiments, apparatus, or configurations, and as such can, of course, vary. It should be readily understood that the aspects of the present disclosure, as generally described herein, and illustrated in the figures, can be arranged, substituted, combined, separated, and designed in a wide variety of different configurations. It is also to be understood that the terminology used herein is for the purpose of describing particular aspects only, and unless specifically defined herein, is not intended to be limiting.

Throughout this specification, unless the context requires otherwise, the words “comprise” and “include” and variations (e.g., “comprises,” “comprising,” “includes,” “including,” “has,” and “having”) will be understood to imply the inclusion of a stated component, feature, element, or step or group of components, features, elements, or steps, but not the exclusion of any other component, feature, element, or step or group of components, features, elements, or steps.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

As used in the specification and the appended claims, the singular forms “a,” “an,” and “the” include plural referents unless the context clearly dictates otherwise.

Ranges can be expressed herein as from “about” one particular value and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

Any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

The technology disclosed herein relates to an electrified photoreactor chamber having a thin catalyst bed and short gas flow residence time suitable for carrying out gas-phase catalytic reactions under light illumination. The input energy for catalyzing the reaction is supplied from light produced by one or more lighting devices, such as an array of light-emitting diodes (LEDs) or other solid-state lighting devices, arc lamps, or Ultraviolet (UV) bulbs, for example. The lighting device(s) are ideally, but need not be, powered by renewable electricity to provide a reduced carbon footprint compared to conventional thermal plants that require the burning of fossil fuels.

While the appended claims set forth the bounds of the invention to which protection is sought, various example embodiments described herein are directed to a vertically arranged photoreactor having one or more of the following features:
A photocatalyst bed having a thin layer of horizontally arranged photocatalyst, such as where the thin layer has a thickness of 1 cm or a thickness of 2 cm or a thickness of 3 cm or a thickness of between 1 cm and 3 cm, inclusive, or a thickness greater than 1 cm or a thickness less than 3 cm. The thin layer has a cylindrical shape for a cylindrical reactor or a rectangular prism shape for a reactor shaped as a rectangular prism, for example. In general, the shape of the thin layer will be a similar or identical shape as the shape of the photoreactor reactor chamber, scaled-down in size (primarily thickness).
The photocatalyst bed is extended over its full (or substantially its full) radius, width, length, or other lateral dimension in the horizontal reactor axis with a thickness-to-radius ratio smaller than 1.0.
Reactant gas is passed vertically, from top to bottom, through the horizontally-arranged photocatalyst bed.
The photocatalyst bed is supported on a gas-permeable plate.
The photocatalyst bed is fixed, not fluidized.
A horizontally arranged lighting source, such as an LED module (or other solid-state lighting source), arc lamp(s), IR bulb(s), or other type of lighting source, is provided for photocatalyst illumination through an optically transparent window onto the photocatalyst bed.
The active (photon-emitting portion) of the lighting source has a diameter or other lateral dimension approximately (i.e., almost) equal to the inner diameter of the photoreactor and to the diameter of the photocatalyst bed.

A thin catalyst bed layer was previously adapted for use in a conventional (non-photocatalytic) reactor with the catalyst bed arranged in the direction of flow (lateral or horizontal gas flow) as opposed to gas flow going through the bed (i.e., vertical flow, as utilized in the presently disclosed example embodiments). See, for example, the reactor set forth in U.S. Pat. No. 5,484,576. Alternatively, axial thin-layer thermocatalytic reactors with a vertically arranged and relatively long catalyst bed have been developed having gas flow perpendicular to the bed. See, for example, the non-photocatalytic reactors set forth in U.S. Pat. No. 8,101,140 and U.S. Patent Application Publication No. 2011/0133126A1. The design configurations of the aforementioned conventional reactors are not compatible for efficient photocatalysis with a photo-active material under light illumination.

The presently described example embodiments can address multiple technological challenges associated with producing commodity chemicals and fuels at an industrially relevant scale. En-route to sustainability, the technologies set forth herein can be applied toward realizing low-cost, zero-emission chemical manufacturing by providing a light-driven solution alternative to conventional petroleum-based thermal catalysis, in line with the climate target of the Paris Agreement. Additionally, the disclosed technologies address a long-standing challenge in catalysis of several energetically, industrially, and environmentally critical chemical reactions by providing a path to surpass the reaction thermodynamic equilibrium and promoting reactions rates beyond what is dictated by thermal equilibrium, while utilizing substantially milder operating conditions compared to traditional heat-powered plants. This will potentially reduce the energy cost and improve the efficiency of the chemical transformations.

Current potential applications for the presently disclosed technology are in low-temperature photocatalysis of reactions that suffer from antagonistic kinetic and thermodynamic desires, such as ammonia (NH₃) synthesis from N₂ and H², and reactions wherein controlling product selectivity and catalytic stability is critical, such as partial dehydrogenation of alkanes, ethane, and propane to ethylene and propylene, respectively. Ammonia, ethylene, and propylene are among the most valuable and fundamental chemical commodities globally, but the current processes for making them are extremely energy-intensive. More than 96% of global ammonia production utilizes the Haber-Bosch (HB) process, which accounts for ˜2% of the world's fossil energy usage and over 1.5% of global CO₂ emissions, according to some estimates. Sustainable production of green ammonia through the presently described technology can assist in reducing carbon emissions while enabling the transition from fossil fuels to a zero-carbon energy industry. Similarly, industrial propylene and ethylene production are the second-and third-largest carbon emitters in the chemical industry after ammonia. For these two reactions, harsh reaction conditions also accelerate the particle sintering and lead to undesirable side reactions of coke formation and hydrogenolysis, thus compromising the products' efficiency, stability, and selectivity. Example embodiments set forth herein may allow for more sustainable and selective ethylene and propylene production than in conventional systems and methods. Other potential applications may also be realizable using the example photoreactor designs and features set forth herein.

### II. EXAMPLE PHOTOREACTOR DESIGN

Throughout this description and in the appended claims, terms or phrases such as “vertical,” “vertically arranged,” “top,” “bottom,” “upper,” “lower,” “over,” “under,” “above,” “below,” “horizontally,” “horizontally arranged,” and other relative descriptors are to be construed in relation to a predetermined frame of reference, such as a primary gravitational source (e.g., the Earth) or a direction to which a product gas exits a reactor. Therefore, for example, “vertically arranged” generally means an arrangement of adjacent components (e.g., “horizontal” layers) extending generally orthogonally away from the Earth's surface (or away from the direction to which the product gas exits the reactor) with relatively “lower” components being closer to the Earth's surface (or closer to the direction to which the product gas exits the reactor) than relatively “higher” components. The “top” of such an arrangement or component is to be construed as the furthest or nearly furthest away from the Earth's surface (or furthest or nearly furthest away from the direction to which the product gas exits the reactor), while the “bottom” is the opposite. In contrast to “vertically arranged,” the phrase “horizontally arranged” means arrangement of adjacent components in which the collective arrangement (e.g., as defined by a central axis through the arrangement) is generally co-planar with or parallel to the Earth's surface (or orthogonal or perpendicular to the direction to which the product gas exits the reactor). Similarly, a “horizontally arranged” component is a component having a longest linear measurement (e.g., a diameter, length, or width) that is generally co-planar with or parallel to the Earth's surface (or orthogonal or perpendicular to the direction to which the product gas exits the reactor) compared to a vertical linear measurement (e.g., a height) that is orthogonal to the Earth's surface (co-linear with the direction to which the product gas exits the reactor).

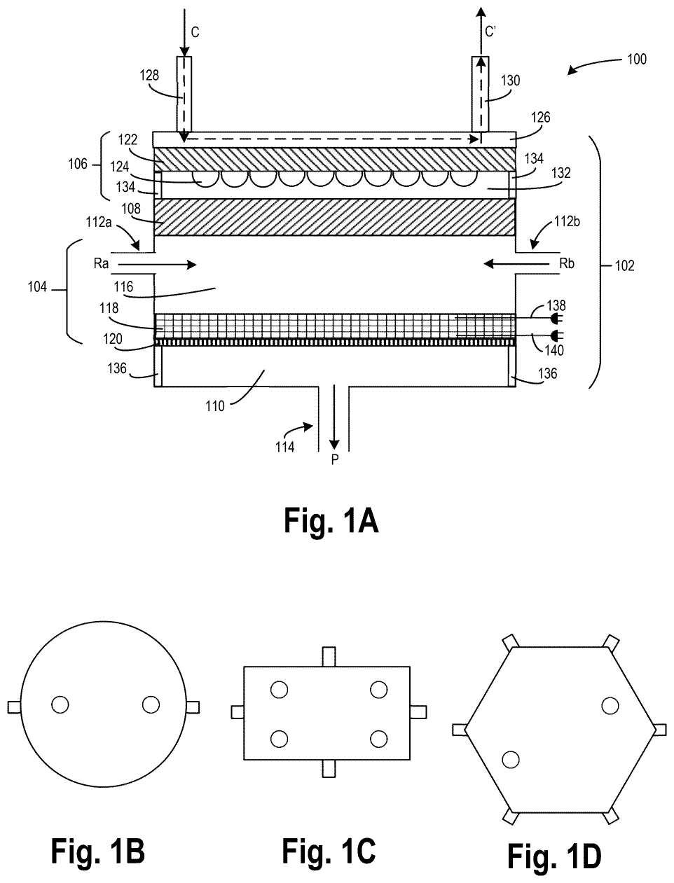

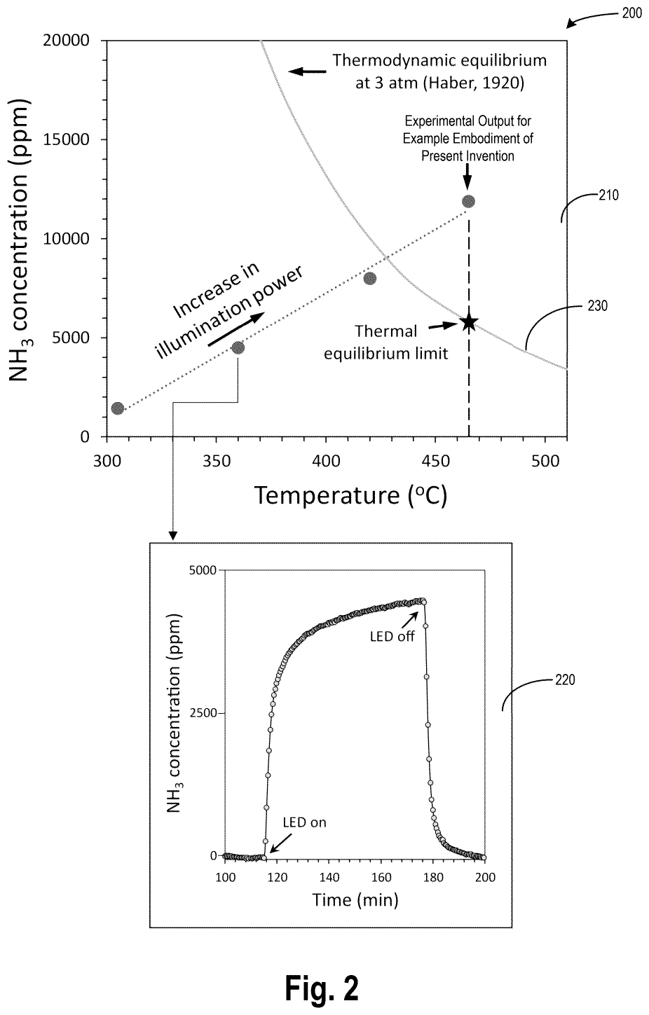

FIG. 1A is a simplified longitudinal sectional diagram illustrating a photoreactor 100 for industrially relevant chemical reactions, according to a first example embodiment. While described herein as a “photoreactor,” the illustrated photoreactor 100 is a photoreactor chamber and components as shown and described below, but with other external components and systems omitted for clarity. Examples of omitted external components and systems that might be included in a photoreactor being used for industrial chemical production include gas lines/tubing/piping, valves, pumps, sensors, heaters, chillers, condensers, storage/supply tanks, power supplies, control systems, safety equipment, and post-production equipment and/or systems. Candidate reactions for the photoreactor 100 include, but are not limited to, ammonia synthesis, for which experimental results are described with reference to FIG. 2, as well as the partial dehydrogenation of alkanes, ethane, and propane to ethylene and propylene, described in further detail below.

For the example of FIG. 1A, photoreactor 100 will be described as having generally a cylindrical shape (i.e., a cylindrical reactor chamber and other cylindrical components are stacked to form a cylinder, having a circular cross-section when viewed from above, as shown in FIG. 1B). However, the photoreactor 100 may alternatively have a different shape, such as a three-dimensional shape (e.g., a rectangular prism) having a rectangular, square, or other regular or non-regular polygonal or oval (or other) cross-section, which may, but need not, have a consistent width (e.g., diameter) for the entire height of the photoreactor 100. FIG. 1B illustrates a simplified top view of the example cylindrical photoreactor 100 illustrated in FIG. 1A, while FIGS. 1C and 1D illustrate simplified respective top views of rectangular and hexagonal variations of the photoreactor illustrated in FIG. 1A. FIGS. 1B, 1C, and 1D also illustrate example placement and quantities of reactant gas inlets and coolant inlets and outlets, described in further detail below with respect to FIG. 1A.

The photoreactor 100 includes a vertically arranged body 102 constructed of a high-pressure-rated material (e.g., rated for at least four standard atmospheres (405.3 kPa) of pressure), such as one or more structural alloys of steel or nickel, titanium, aluminum, or quartz. As discussed above, the body 102 (and some or most other components of the photoreactor 100) are cylindrical in the example of FIG. 1A; in non-cylindrical variations, the other components would generally have a similar or related shape (e.g., same cross section) as that of the body of the reactor, according to alternative example embodiments. Positioned within and/or constituting part of the cylindrical body 102 of the photoreactor 100 in a vertical arrangement are a cylindrical photoreactor chamber 104, a lighting source 106, an optically transparent window 108, a product gas compartment 110, reactant gas inlets 112a and 112b for receiving respective reactant gas feed streams Ra and Rb, and product gas outlet 114 for outputting a product gas P. The photoreactor chamber 104 further includes a chamber compartment 116 and a thin catalyst bed layer 118 on a gas-permeable plate 120.

In the illustration of FIG. 1A, the body 102 is shown as constituting substantially the entire height of the photoreactor 100, with other components such as the photoreactor chamber 104, lighting source 106, window 108, and product gas compartment 110 shown stacked within the body 102. Such a configuration requires relatively tight physical tolerances, perhaps with spacer rings or other positioning mechanisms to maintain the illustrated physical spacing relationships between components. In an alternative vertical-arrangement configuration, the body 102 constitutes only portions of the photoreactor chamber 104 and product gas compartment 110, while the window 108 and lighting source 106 are stacked on top of the body 102, resulting in a sandwich-style construction of the photoreactor 100. In this alternative configuration, components such as the window 108 and lighting source 106 may be designed to have the same or even slightly larger diameter as the outer diameter of the body 102, such that the window 108 rests on top of the upper circular lip of the body 102 and the lighting source 106 rests on top of the window 108. In still yet another alternative configuration, the interior of the body 102 includes the photoreactor chamber 104, the window 108, and the product gas compartment 110, while the lighting source 106 rests on top of the upper circular lip of the body 102, which may be even with the upper surface of the window 108 or which may extend beyond the upper surface of the window 108, as described in further detail below. In either of the aforementioned alternative configurations, the vertically stacked components of the photoreactor 100 can be clamped together or otherwise secured to one-another, such as by one or more adhesives and/or mechanical fasteners. Furthermore, as discussed above, for a non-cylindrical body 102, rather than having circular cross-sectional shapes with corresponding diameters, the stacked components may have other cross-sectional shapes and length-width dimensions; however, similar concepts still apply for the above-described example configuration variations.

In the illustrated example, the lighting source 106 is a horizontally-arranged solid-state lighting source in the form of a Light-Emitting Diode (LED) array consisting of a substrate 122 having plurality of LEDs 124 densely arranged on the bottom surface of the substrate 122. For example, the substrate 122 may be a printed circuit board (PCB) having traces connecting the plurality of LEDs to power and/or control circuitry (not illustrated). For example, such power and/or control circuitry may include an on-demand (intermittent) energy source or switch for powering-on and powering-off the lighting source, thereby providing for a corresponding on-demand reaction in the photoreactor chamber 104. As another example, the lighting source 106 may include a plurality of LED circuit boards adjacent to one another, with each LED board comprising a plurality of LEDs, such as thousands of LEDs that are each around 1-5 mm across. In embodiments in which the lighting source 106 utilizes LEDs, the LEDs may be selected to emit photons in the ultraviolet-to-visible-light spectrum (i.e., from about 200 nm to about 750 nm) or in the visible light spectrum (i.e., from about 380 nm to about 750 nm), for example. Alternatively or additionally, the lighting source 106 may include a plurality of infrared (IR) lamps mounted via sockets, connectors, pins, wires, or other configurations, to emit photons in the near-IR spectrum (i.e., from about 750 nm to about 2,500 nm). Other example embodiments may include a lighting source utilizing other types of photon emitters, such as one or more ultraviolet (UV) lamps and voltaic arc lamps. In general, to promote efficient photocatalysis, the lighting source 106 is selected and/or controlled (e.g., via control circuitry on or electrically coupled to the lighting source 106, such as on the substrate 122) to emit photons having a sufficient energy (i.e., peak irradiance (intensity) and energy density) and wavelength to activate desired photo-induced gas-phase reactions.

To maximize the number of incident photons hitting the upper surface of the catalyst bed layer 118, the lighting source 106 preferably emits photons incident onto substantially the entire upper surface of the window 108 and into the photoreactor chamber 104. Thus, in example embodiments, the diameter or width of the active (photon-emitting) portion of the lighting source 106 is approximately the same as the diameter of the window 108 and the diameter of the catalyst bed layer 118 or perhaps slightly narrower to account for the light-emitting angle (beam angle) of the photon emitter(s). In addition, the diameter of the substrate 122 of the lighting source 106) is approximately equal to the inner diameter of the body 102 (in an internal, press-fit configuration, as illustrated) or to the outer diameter of the body 102 (in a stacked configuration). The plurality of photon emitters (e.g., LEDs 124) may be arranged across substantially the entirety of the substrate 122, with each photon emitter spaced from adjacent photon emitters (or the body 102 or other component) in accordance with specified design requirements, such as those relating to power or control considerations or to damage protection from heat or photon emissions from immediately adjacent photon emitters. In an example embodiment utilizing LEDs, the lighting source 106 includes approximately 20,000-125,000 individual LEDs, with each LED being approximately 1-5 mm wide, mounted on a PCB substrate 122 having a diameter of around 91 cm. In other example embodiments, different densities of photon emitters may be possible and/or preferred, depending on design requirements, cooling systems, and/or power/control circuitry, for example.

The lighting source 106 is selected and/or controlled to emit photons at a particular target wavelength or wavelength range (or at a particular plurality of target wavelengths or wavelength ranges) in the electromagnetic spectrum. Such target wavelength or wavelength range is chosen to catalyze a desired chemical reaction by maximizing absorption in the catalyst bed layer 118 of that target wavelength or wavelength range. For example, the catalyst bed layer 118 may have a catalyst coupled to a plasmonic material (i.e., a plasmonic photocatalyst) having a plasmon resonant frequency corresponding to the selected target wavelength or wavelength range. Matching the plasmon resonant frequency with the target wavelength or wavelength range may be accomplished via design of the plasmonic photocatalyst or selection/control of the specific photon emitter(s) or both, for example.

The lighting source 106 may optionally include a physically adjacent cooling block 126 (or more than one such cooling block 126), which may take the form of a heat sink (e.g., with cooling fins), a cooling fan, or a fluid-cooling system, for example. In the illustrated example, the cooling block 126 includes one or more cooling passages or chambers through which a coolant C may be passed, as illustrated in simplified schematic form by the dashed lines and arrows shown in FIG. 1A. As shown, the coolant C is introduced into the cooling block 126 through one or more coolant inlets 128 and is removed (as spent coolant C′) via one or more coolant outlets 130. In some example embodiments, coolant C is recirculated, in a closed-loop system, by a pump (not shown) through the cooling block 126 after passing through a heat exchanger (not shown) to remove heat from the spent coolant C′. In other example embodiments, the spent coolant C′ is not recirculated through the cooling block 126 and is instead disposed of or utilized elsewhere (e.g., for heating purposes in another related or unrelated process). In yet other example embodiments, the coolant C that is circulated through the cooling block 126 may include a portion of the product gas P originating from the product gas outlet 114, such as via a valve and dedicated cooling loop with an inline chiller coupled to the coolant inlet 128.

In embodiments in which the lighting source 106 utilizes a cooling block 126 as illustrated in FIG. 1A, the coolant C may be selected from the following non-exhaustive list, for example: water, ammonia, synthetic hydrocarbons of aromatic chemistry (i.e., diethyl benzene [DEB], dibenzyl toluene, diaryl alkyl, partially hydrogenated terphenyl), silicate-esters, aliphatic hydrocarbons of paraffinic and iso-paraffinic type, dimethyl- and methyl phenyl-poly (siloxane), fluorinated compounds such as perfluorocarbons (i.e., FC-72, FC-77) hydrofluoroethers (HFE), and perfluorocarbon ethers (PFE), ethylene glycol, propylene glycol, methanol/water, ethanol/water, calcium chloride solution (e.g., 29% by wt.), aqueous solutions of potassium formate and acetate salts, and liquid metals (e.g., Ga—In—Sn). In general, the coolant C is chosen to have a predetermined heat capacity that meets desired cooling requirements, such as those specified for the photo emitters utilized in the lighting source 106.

In the illustrated example embodiment, the optically transparent window 108 is a cylindrical disk adjacent to the lighting source 106, between the lighting source 106 and chamber compartment 116 of the photoreactor chamber 104. While illustrated as a single component having a flat monolithic construction to serve as a simple optical window, the window 108 may comprise more than one physical component, and either or both the upper or lower surface of the window 108 may have a slight curvature to act as a lens (e.g., to control the angle(s) of light transmission from the lighting source 106 onto the catalyst bed layer 118. The optical transparency of the window 108 is with respect to the wavelength or wavelength range of photons emitted by the lighting source 106, such that light passes from the lighting source 106 through the window 108 and into the photoreactor chamber 104 without appreciable scattering. In other words, the photons emitted by the lighting source 108 generally follow Snell's law as they pass through the window 108. As a result, photons emitted by the lighting source 106 are able to pass through the window 108 and chamber compartment 116 (which contains only pressurized reactant gas from reactant gas feed streams Ra and Rb) to strike the top of the catalyst bed as incident photons. Utilizing target wavelengths and wavelength ranges in the example spectrum ranges set forth herein, in order to provide such optical transparency, the window 108 is constructed of glass, quartz, or other optically transparent material, such as sapphire or a transparent ceramic.

The surface of the window 108 that is adjacent to the photoreactor chamber 104 serves as a ceiling (top gas-impermeable enclosing surface) of the photoreactor chamber 104. As such, the window 108 needs to have a sufficient thickness (e.g., a thickness of 1 cm or greater, such as 5 cm) or construction to withstand pressures (plus a tolerance) imposed by the reactant gas feed streams Ra and Rb flowing through the respective reactant gas inlets 112a and 112b into the photoreactor chamber 104.

While the window 108 is adjacent to the lighting source 106, the window 108 is not in direct physical contact with the photon emitters (e.g., LEDs 124) of the lighting source 106, according to example embodiments. Instead, a void 132 is provided in the cylindrical body 102 above the window 108, between the window 108 and the photon emitters (e.g., LEDs 124) mounted on the substrate 122. The thickness of the void 132 may be defined by a thin circumferential spacer ring 134, for example, that is constructed of metal or another heat-resistant, preferably reflective material with a similar coefficient of thermal expansion to that of the body 102. The void 132 may be filled with an optically transparent non-flammable gas, such as air or nitrogen, or may instead consist of a vacuum.

As an alternative to the spacer ring 134, the void 132, if included, may be defined by a ridge or protrusion (e.g., a circular circumferential ring protrusion, in the case of a cylindrical photoreactor 101) extending from a surface of either the substrate 122 of the lighting source 106 or the window 108, to provide separation between the window 108 and the photon emitters 124 of the lighting source 106. As yet another alternative, the walls of the cylindrical body 102 could extend up past the upper surface of the window 108 (with the window 108 positioned inside the body 102) to provide a circumferential lip (e.g., similar to the spacer ring 134 described above) upon which the substrate 122 (or other portion of the lighting source 106) can be positioned to create the void 132. Depending on the particular configuration of the photoreactor 100 (i.e., whether components are housed within the body 102 or stacked on top of the cylindrical body 102), the spacer ring 134 may have an inner diameter (or other length/width dimension) equal to that of the body 102 (in a stacked configuration) or an outer diameter almost equal to the inner diameter of the body 102 (in an internal, press-fit configuration). To maximize the number of incident photons hitting the upper surface of the catalyst bed layer 118, the plurality of photon emitters (e.g., LEDs 123) of the lighting source 106 preferably emit photons onto substantially the entire surface area above the window 108 (assuming the window 108 has no curvature to act as a lens) and into the photoreactor chamber 104. This can be realized by minimizing the thickness of the spacer ring 134 (in an internal, press-fit configuration) or constructing the ring to have an inner diameter equal to that of the body 102 (in a stacked configuration), to avoid blocking light transmission.

Returning to the example embodiment of FIG. 1A, reactant gas feed streams Ra and Rb may be provided via respective reactant gas inlets 112a and 112b (in one or more vertical sidewalls of the body 102) as continuous flows of one or more pressurized reactant gas(es) into the chamber compartment 116 of the photoreactor chamber 104. While two reactant gas inlets 112a and 112b are illustrated, other example embodiments may include three or four (or more) reactant gas inlets or a single reactant gas inlet, each with a respective reactant gas feed stream providing a continuous flow of pressurized reactant gas. The number of reactant gas inlets may depend on how many different reactant gases are being reacted, the size of the reactor body 102 (e.g., a larger sized body 102 may call for a greater number of reactant gas inlets), and/or the desired reactant gas pressure in the chamber compartment, for example.

The reactant gas feed stream Ra may contain the same or a different process gas or (gases) than reactant gas stream Rb contains. For example, where the photoreactor 100 is used for ammonia (NH₃) synthesis, the reactant gas feed stream Ra may include primarily nitrogen (N₂) as a first process gas and the reactant gas feed stream Rb may include primarily hydrogen (H₂) as a second process gas. The two streams Ra and Rb will then mix in the chamber compartment 116, with the nitrogen (N₂) and hydrogen (H₂) reacting as the mixed process gases flow through the catalyst bed layer 118 (while being illuminated by the lighting source 106) to produce ammonia (NH₃) as a product gas. In an alternative ammonia-synthesis photoreactor 101, the reactant gas feed stream Ra and the reactant gas feed stream Rb may each contain a controlled mix of nitrogen (N₂) process gas and hydrogen (H₂) process gas, to be synthesized into an ammonia (NH₃) product gas in the photoreactor chamber 104. As another example, the reactant gas feed streams Ra and Rb each include primarily ethane (C₂H₆) as a process gas, which reacts in the photoreactor chamber 104 via a photocatalytic selective partial dehydrogenation process to create ethylene (C₂H₄) as a product gas P. As yet another example, the reactant gas feed streams Ra and Rb each include primarily propane (C₃H₈) as a process gas, which reacts in the photoreactor chamber 104 via a photocatalytic selective partial dehydrogenation process to create propylene (C₃H₆) as a product gas P.

During operation, the reactant gas feed streams Ra and Rb introduce a continuous flow (or flows) of process gas into the chamber compartment 116. The introduced process gas then passes vertically through the thin catalyst bed layer 118 from top to bottom and flows through the gas-permeable plate 120 into the product gas compartment 110 as product gas P. The product gas P is output as a continuous flow (during operation) through product gas outlet 114. As described above with respect to the cooling block 126, for some product gases (e.g., Ammonia (NH₃)), a portion of the product gas P stream output from the product gas outlet 114 may be utilized as the coolant C (or a component thereof) in the cooling block 126.

The catalyst bed layer 118 is a photocatalyst packed bed (or “fixed bed,” rather than a “fluidized bed”) having a photocatalyst on a support material. For example, the catalyst bed layer 118 may include a photocatalyst co-precipitated with a support material. The photocatalyst may comprise antenna-reactor plasmonic nanoparticles, for example. Various antenna-reactor catalysts developed by Rice University are described in U.S. Pat. No. 10,766,024 (incorporated by reference herein) and can effectively utilize light energy to perform various chemical reactions. For example, such antenna-reactor catalysts can be used in the example photoreactor embodiments described herein to provide high conversion at high space velocity, resulting in a relatively high product gas production rate per unit volume of catalyst bed. Depending on the type of chemical reaction to be performed, an appropriate antenna-reactor catalyst can be matched with correspondingly appropriate photo emitters (e.g., LEDs 124) to efficiently activate the photocatalyst, thereby resulting in relatively higher reaction rates compared to conventional plasmonic photocatalysts or non-plasmonic photocatalysts.

In example embodiments, the support material in the catalyst bed layer 118 exhibits relative optical transparency (reduced absorption or scattering, compared to an opaque material) at the target wavelength or wavelength range for the desired chemical reaction, to promote light transmission a greater distance into the catalyst bed layer 118. In some example embodiments, the support material comprises silica, quartz, fused quartz, glass, borosilicate glass, aluminosilicate glass, lithium-aluminosilicate glass, sapphire, diamond, transparent aluminum oxide (such as α-phase aluminum oxide or γ-phase aluminum oxide), cesium oxide, magnesium oxide, or iron oxide, and is in the form of powder, alloy, beads, microporous beads, fibers, spheres, pellets, cylinders (hollow or otherwise), honeycombs, or symmetrical or asymmetrical tri-quadrulobes (for example, using extrusion or tableting methods).

In example embodiments, the catalyst bed layer 118 is formed by filling photocatalyst material (photocatalyst and support material) onto the gas-permeable plate 120, which supports the catalyst bed layer 118 and prevents the photocatalyst and/or its support material in the catalyst bed layer 118 from falling towards the product gas compartment 110. The gas-permeable plate 120 may be a perforated plate. The gas permeable plate 120 may consist of or include a metal grid that is electrically heated to enhance catalyst performance for particular chemical reactions.

To maintain the gas-permeable plate 120 at a fixed position within the body 102 of the photoreactor 100, a circumferential spacer ring 136 (e.g., constructed of metal or another material) may be provided with a height equal to the desired height of the product gas chamber 110 within the body 102 and an outer diameter approximately equal to the inner diameter of the body 102. Other positioning techniques may be utilized for the gas-permeable plate 120, such as those utilizing static friction (press-fit) force or a ridge built-into the inner wall of the body 102.

In example embodiments, the catalyst bed layer 118 is cylindrical (or otherwise generally matching the shape-type of the body 102), extending horizontally across the entire inner diameter of the body 102 of the photoreactor 100. In addition, the catalyst bed layer 118 is relatively thin (in height) compared to its diameter/length-width, with example embodiments having a thickness of 1 cm or a thickness of 2 cm or a thickness of 3 cm or a thickness of between 1 cm and 3 cm, inclusive, or a thickness greater than 1 cm or a thickness less than 3 cm. According to example embodiments, the catalyst bed layer 118 has a thickness-to-radius ratio smaller than 1.0. The thickness of the catalyst bed layer 118 may be optimized against the space velocity (gas feed rate) for a particular chemical reaction.

The relative thin photocatalyst bed of catalyst bed layer 120 provides technical benefits. One such benefit is a reduced pressure drop across the catalyst bed layer 120. In addition, as described in the following paragraph, a relatively thin photocatalyst bed may additionally allow for controlling industrially relevant and high-impact chemical reactions.

Due to strong light-matter interactions, the photon penetration depth into optically active metal catalysts is typically limited to only a few hundred microns. Strong photon absorption results in an intense catalyst heating and generation of localized heat zone (hot spots) on the top catalyst surface under illumination, and thus a large vertical temperature gradient across the catalyst bed depth and in the direction of gas flow with the bottom side of the catalyst being at a much lower temperature. See Robatjazi, H., Zhao, H., Swearer, D. F. et al. Plasmon-induced selective carbon dioxide conversion on earth-abundant aluminum-cuprous oxide antenna-reactor nanoparticles. Nat Commun 8, 27 (2017). https://doi.org/10.1038/s41467-017-00055-z, the entirety of which is incorporated by reference herein for all purposes. Such a temperature gradient can be uniquely exploited, along with other photon-assisted bond activation mechanisms (e.g., non-thermal or electronic effects), to enable a number of industrially relevant chemical reactions to proceed under light illumination. These photocatalytic reactions exhibit efficiencies beyond those controlled by thermal equilibrium in conventional thermal catalysis in the heat-powered plant, for example, for driving reactions that suffer from antagonistic kinetic and thermodynamic desires. One example is ammonia (NH₃) synthesis from nitrogen (N₂) and hydrogen (H₂). For this reaction, the intense catalyst heating at the top surface of the catalyst bed layer 118 under illumination creates a “hot catalyst zone” that is desirable for the dissociation of N₂ with a large activation barrier. In contrast, a “cold catalyst zone” near the bottom of the catalyst bed layer 118 and opposite the lighting layer 106 facilitates N—H bond formation and NH₃ desorption, which otherwise is readily decomposed back to its constituents at a high catalyst bed temperature (i.e., the case in conventional thermal catalysis). Therefore, a light-induced temperature gradient could effectively enable low-temperature ammonia synthesis using only light as the energy input into the photoreactor chamber with efficiencies beyond what is dictated by thermodynamic equilibrium in thermal plants with uniform catalyst bed temperature. Based on the magnitude of the temperature gradient, it is possible to maximize the effective volume-to-mass ratio of the catalyst contributing to photocatalysis by utilizing a relatively minimal catalyst bed depth. Additionally, a short gas residence time within the thin catalyst layer could also minimize the possibility of ammonia decomposition via the backward reaction. Other potential applications of such a photoreactor design having a relatively thin catalyst bed layer are in partial dehydrogenation processes, such as in improving ethylene's selectivity over acetylene in photocatalytic dehydrogenation of ethane.

To assist in measuring the above-discussed temperature gradient between the top and bottom of the catalyst bed layer 118, example embodiments of the photoreactor 100 may further optionally include two (or more) thermocouples 138 and 140 in two (or more) respective optional feed-through entries in the body 102 for measuring the respective top and bottom surface temperatures of the catalyst in the catalyst bed layer 118. Intermediate temperatures may be taken via one or more additional intermediate thermocouples in the catalyst bed layer 118, in another example embodiment.

In alternative embodiments, an embedded heating unit (not shown), such as an embedded coil or grid heater or a plurality of embedded IR lamps can be provided in the catalyst bed layer 118 to supply heating for particular chemical reactions. In such embodiments, the catalyst bed layer 118 might be made thicker than in the examples described above, in order to accommodate the embedded heating unit and/or to create a predetermined temperature differential across the catalyst fixed bed.

As one example design implementation of the photoreactor 100 illustrated in FIG. 1A, the photoreactor 100 could be a cylindrical photoreactor provided with a catalyst bed layer 118 having a diameter of 91 cm and a corresponding LED module (serving as part of the lighting source 106) having an active diameter (i.e., of photon emitters, such as LEDs 124) of 84.4 cm. This LED module could contain between 20,000 and 125,000 individual LEDs, according to one example. Assuming a 90% efficiency in transmission of photon energy from the surface of the LED module to the surface of the catalyst bed layer 118, an incident light intensity of up to 40 W/cm² (at the surface of the catalyst bed layer 118) can be achieved with this example design.

### III. EXPERIMENTAL DATA

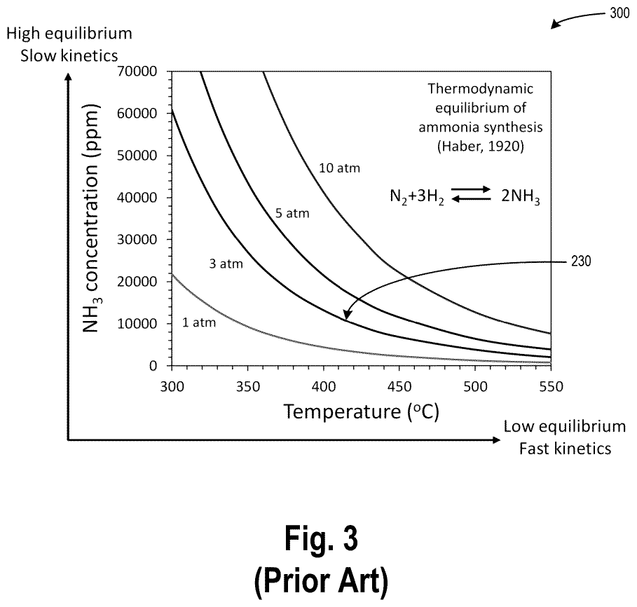

FIG. 2 is a graphical diagram 200 illustrating experimental data for photocatalytic ammonia synthesis utilizing a photoreactor design corresponding to the photoreactor 100 of FIG. 1A. In particular, FIG. 2 shows ammonia production yield at 3 atmospheres of pressure as a function of temperature (see below) compared with thermal equilibrium limits according to Haber and le Rossignol. See Smil, V., Enriching the Earth: Fritz Haber, Carl Bosch, and the Transformation of the World Food Production, MIT Press, Cambridge, MA, 2001. The diagram 200 of FIG. 2 includes an upper portion 210 that illustrates ammonia production as a function of increasing illumination power (with corresponding increased measured bulk temperatures resulting from light-induced heating) and a lower portion 220 that illustrates real-time monitoring data of the concentration (ppm) of synthesized ammonia. The upper portion 210 includes a 3 atm ammonia synthesis thermodynamic equilibrium curve 230 taken from the “thermodynamic equilibrium of ammonia synthesis” graph shown in FIG. 3, from Haber, 1920.

Photocatalytic ammonia synthesis was performed with (a) the process gas being provided at 3 atm of pressure in the chamber compartment 104, (b) the lighting source 106 emitting light in the visible spectrum, (c) the catalyst bed layer containing 4 grams of catalyst, and (d) a measured bulk temperature of up to approximately 465 degrees C. The apparent temperatures (x-axis of the upper portion 210 of the diagram 200) associated with photocatalysis refers to the measured bulk temperatures resulting from light-induced heating of the catalyst under various illumination power (see the diagonal “increase in illumination power” trendline showing increased ammonia production corresponding to increased illumination) with no additional external heating applied in photocatalysis.

As shown in the upper portion 210 of the diagram 200, ammonia was synthesized up to approximately 14,000 ppm, which surpasses the limit of thermal equilibrium (see the starred “Thermal equilibrium limit” in the upper portion 210 of the diagram 200) in ammonia synthesis on the 3 atm thermodynamic equilibrium curve 230 by approximately 100%. The experimentally observed photocatalytic reaction rates are substantially higher than what can be achieved in conventional thermal processes at the given pressure and temperature. The results indicate a potential for the technology described herein to achieve conversion rates beyond that of conventional Haber-Bosch (15%), at milder operating conditions (lower pressures and temperatures). While the experimental results presented herein are with respect to a particular process gas pressure, light wavelength, illumination power, catalyst amount/concentration, and measured light-induced heating, other experimental setups are also contemplated to provide beneficial results, such as in synthesizing ammonia at rates/amounts beyond the limit of thermal equilibrium.

The lower portion 220 of the diagram 200 of FIG. 2 shows a real-time monitoring of the concentration (ppm) of the synthesized ammonia at a particular illumination and corresponding measured bulk temperatures resulting from light-induced heating of the catalyst. As illustrated, (a) ammonia production begins near-instantaneously in response to powering-on the lighting source (steep upward slope beginning at “LED on”), (b) ammonia production approaches steady-state (slope flattens, approaching 4000+ ppm) within a few tens of minutes after powering-on the lighting source, and (c) ammonia production ceases within a few tens of minutes in response to powering-off the lighting source (steep downward slow beginning at “LED off”). The near-instantaneous response of the system to light-on/light-off could allow for use of an intermittent (e.g., switchable) energy source for widespread decentralized on-demand ammonia production.

### IV. EXAMPLE EMBODIMENTS

The following are example embodiments of the technology described herein.

### Example 1

A photoreactor, comprising:
a. a photoreactor body comprising a vertical length with a top end and a bottom end;
b. an inlet disposed on a sidewall of the photoreactor body between the top end and the bottom end, wherein the inlet is for receiving a continuous-flow feed stream of a process gas;
c. an outlet disposed at the bottom end of the photoreactor body for discharging a product gas stream;
d. a gas-permeable plate disposed in an interior of the photoreactor body below the inlet and above the outlet;
e. a product gas compartment in the interior of the photoreactor body defined by a space between the perforated plate and the bottom end of the photoreactor body;
f. a catalyst fixed bed disposed as a catalyst bed layer in the interior of the photoreactor body adjacent to the perforated plate and opposite the product gas compartment;
g. an optically transparent window disposed at the top end of the photoreactor body;
h. a chamber compartment in the interior of the photoreactor body defined by the space between the catalyst fixed bed and the optically transparent window such that the inlet provides the continuous-flow feed stream of the process gas into the chamber compartment; and
i. a lighting source having a plurality of photon emitters positioned adjacent to but not contacting the optically transparent window, wherein the lighting source emits photons through the optically transparent window and the chamber compartment onto a top surface of the catalyst fixed bed to thereby catalyze a chemical reaction involving the process gas to produce the product gas stream to be output via the outlet.

### Example 2

The photoreactor of example 1, wherein the photoreactor body is cylindrical.

### Example 3

The photoreactor of any of the preceding examples, wherein the lighting source is an LED module and the plurality of photon emitters are a plurality of LEDs on a substrate of the LED module.

### Example 4

The photoreactor of any of the preceding examples, further comprising a cooling block adjacent to the lighting source.

### Example 5

The photoreactor of example 4, wherein the cooling block comprises a fluid inlet to introduce a coolant into the cooling block and a fluid outlet to remove the coolant from the cooling block after the coolant has circulated through a portion of the cooling block.

### Example 6

The photoreactor of any of the preceding examples, wherein the photoreactor body is constructed of a high-pressure rated material.

### Example 7

The photoreactor of example 6, wherein the photoreactor body is rated for at least four standard atmospheres (405.3 kPa) of pressure.

### Example 8

The photoreactor of any of the preceding examples, wherein the photoreactor body is constructed of structural alloys of steel or nickel, titanium, aluminum, or quartz.

### Example 9

The photoreactor of any of the preceding examples, wherein the optically transparent window is a disk constructed of quartz, sapphire, a transparent ceramic, or glass.

### Example 10

The photoreactor of any of the preceding examples, wherein the optically transparent window has a thickness of at least 1 cm.

### Example 11

The photoreactor of any of the preceding examples, wherein the inlet comprises a plurality of inlets.

### Example 12

The photoreactor of any of the preceding examples, wherein the catalyst fixed bed is supported on the gas-permeable plate, and wherein the gas-permeable plate prevents catalyst particles from the catalyst fixed bed from falling into the product gas compartment.

### Example 13

The photoreactor of any of the preceding examples, wherein the catalyst fixed bed has a thickness of between 5 mm and 5 cm.

### Example 14

The photoreactor of any of the preceding examples, wherein the catalyst fixed bed has a thickness that is less than the width of the catalyst fixed bed as disposed on the gas-permeable plate in the photoreactor body.

### Example 15

The photoreactor of any of the preceding examples, wherein the lighting source has a width substantially similar to a width of the photoreactor body to thereby illuminate substantially the entirety of the width of the photoreactor body in the chamber compartment and the top surface of the catalyst fixed bed.

### Example 16

The photoreactor of any of the preceding examples, wherein the lighting source is separated from the optically transparent window by at least one of (a) a metal ring having a width substantially similar to that of the photoreactor body or (b) an extended wall portion of the photoreactor body that extends between the optically transparent window and the lighting source.

### Example 17

The photoreactor of any of the preceding examples, wherein a compartment defined by the space between the optically transparent window and the lighting source is filled by at least one of (a) air, (b) a gas, or (c) a vacuum.

### Example 18

The photoreactor of any of the preceding examples, further comprising:
a. a first thermocouple disposed in an upper portion of the catalyst fixed bed; and
b. a second thermocouple disposed in a lower portion of the fixed bed,
c. wherein the first thermocouple and the second thermocouple provide respective first and second temperature measurements indicative a temperature differential between the upper and lower portions of the catalyst fixed bed.

### Example 19

The photoreactor of example 18, wherein the first and second thermocouples pass through respective feedthrough entries disposed in the sidewall of the photoreactor body.

### Example 20

The photoreactor of any of the preceding examples, wherein during operation, the continuous-flow feed stream of the process gas continuously flows through the inlet into the chamber compartment and reacts, as it passes through the catalyst fixed bed from top to bottom, into a product gas that flows through the perforated plate into the product gas compartment and is discharged via the outlet.

### Example 21

The photoreactor of any of the preceding examples, wherein the lighting source comprises at least one of (a) an IR lamp or (b) an ARC lamp.

### Example 22

The photoreactor of any of the preceding examples, wherein the gas-permeable plate comprises a heated metal grid.

### Example 23

The photoreactor of example 22, wherein the heated metal grid is heated using electricity to enhance catalyst performance.

### Example 24

The photoreactor of any of the preceding examples, wherein the catalyst fixed bed comprises at least one heating element disposed therein.

### Example 25

The photoreactor of example 24, wherein the at least one heating element comprises at least one of (a) an embedded electric heating unit or (b) an IR lamp.

### Example 26

The photoreactor of example 24 or example 25, wherein the catalyst fixed bed is made relatively thicker to accommodate the at least one heating element and to create a predetermined temperature differential across the catalyst fixed bed.

### Example 27

The photoreactor of example 4 or example 5, wherein the product gas comprises ammonia, and wherein the coolant comprises at least a portion of the product gas.

### Example 28

The photoreactor of any of the preceding examples, wherein the process gas includes primarily nitrogen (N₂) and hydrogen (H₂) and wherein the product gas includes ammonia (NH₃).

### Example 29

The photoreactor of example 28, wherein ammonia is synthesized up to approximately 14,000 ppm via the photoreactor when (a) the process gas is provided at 3 atm of pressure in the chamber compartment, (b) the lighting source emits light in the visible spectrum, (c) the catalyst fixed bed contains 4 grams of catalyst, and (d) a measured bulk temperature resulting from light-induced heating of the catalyst fixed bed is up to approximately 465 degrees C.

### Example 30

The photoreactor of example 28, wherein ammonia production begins near-instantaneously in response to powering-on the lighting source, wherein ammonia production approaches steady-state in a few tens of minutes after powering-on the lighting source, and wherein ammonia production ceases within a few tens of minutes in response to powering-off the lighting source.

### Example 31

The photoreactor of any of examples 28-30, further comprising an intermittent on-demand energy source for powering-on and powering-off the lighting source, thereby providing for a corresponding on-demand ammonia production.

### Example 32

The photoreactor of any of examples 1-26, wherein the process gas includes primarily ethane and the product gas includes ethylene created via a photocatalytic selective partial dehydrogenation process.

### Example 33

The photoreactor of any of examples 1-26, wherein the process gas includes primarily propane and the product gas includes propylene created via a photocatalytic selective partial dehydrogenation process.

### V. CONCLUSION

The above detailed description sets forth various features and operations of the disclosed systems, apparatus, devices, and/or methods with reference to the accompanying figures. The example embodiments described herein and in the figures are not meant to be limiting, with the true scope being indicated by the following claims. Many modifications and variations can be made without departing from its scope, as will be apparent to those skilled in the art. Functionally equivalent systems, apparatus, devices, and/or methods within the scope of the disclosure, in addition to those described herein, will be apparent to those skilled in the art from the foregoing descriptions. It will be readily understood that the aspects of the present disclosure, as generally described herein, and illustrated in the figures, can be arranged, substituted, combined, separated, and designed in a wide variety of different configurations. Such modifications and variations are intended to fall within the scope of the appended claims. Finally, all publications, patents, and patent applications cited herein are hereby incorporated by reference for all purposes.

1. A photoreactor, comprising:
a photoreactor body comprising a top end and a bottom end;
an inlet disposed on a sidewall of the photoreactor body between the top end and the bottom end, wherein the inlet is for receiving a continuous-flow feed stream of a process gas during operation;
an outlet disposed at the bottom end of the photoreactor body for discharging a product gas stream;
a gas-permeable plate disposed in an interior of the photoreactor body below the inlet and above the outlet;
a product gas compartment in the interior of the photoreactor body defined by a space between the perforated plate and the bottom end of the photoreactor body;
a catalyst fixed bed disposed as a catalyst bed layer in the interior of the photoreactor body adjacent to the perforated plate and opposite the product gas compartment;
an optically transparent window disposed above the inlet;
a chamber compartment in the interior of the photoreactor body defined by the space between the catalyst fixed bed and the optically transparent window such that, during operation, the inlet provides the continuous-flow feed stream of the process gas into the chamber compartment;
a lighting source positioned adjacent to but not contacting the optically transparent window, wherein the lighting source emits photons through the optically transparent window and the chamber compartment onto a top surface of the catalyst fixed bed to thereby catalyze a chemical reaction involving the process gas to produce the product gas stream to be output via the outlet.

2. The photoreactor of claim 1, wherein the photoreactor body is cylindrical.

3. The photoreactor of claim 1, wherein the lighting source is an LED module comprising substrate having a plurality of LEDs thereon.

4. The photoreactor of claim 1, further comprising a cooling block adjacent to the lighting source.

5. The photoreactor of claim 4, wherein the cooling block comprises a fluid inlet to introduce a coolant into the cooling block and a fluid outlet to remove the coolant from the cooling block after the coolant has circulated through a portion of the cooling block.

6. The photoreactor of claim 5, wherein the product gas comprises ammonia, and wherein the coolant comprises at least a portion of the product gas.

7. The photoreactor of claim 1, further comprising a cooling block adjacent to the lighting source, wherein the cooling block comprises a fluid inlet to introduce a coolant into the cooling block and a fluid outlet to remove the coolant from the cooling block after the coolant has circulated through a portion of the cooling block.

8. The photoreactor of claim 1, wherein the photoreactor body is rated for at least four standard atmospheres (405.3 kPa) of pressure.

9. The photoreactor of claim 1, wherein the photoreactor body is constructed of structural alloys of steel or nickel, titanium, aluminum, or quartz.

10. The photoreactor of claim 1, wherein the optically transparent window is constructed of quartz, sapphire, a transparent ceramic, or glass.

11. The photoreactor of claim 1, wherein the optically transparent window has a thickness of at least 1 cm.

12. The photoreactor of claim 1, wherein the inlet comprises a plurality of inlets.

13. The photoreactor of claim 1, wherein the catalyst fixed bed is supported on the gas-permeable plate, and wherein the gas-permeable plate prevents catalyst particles from the catalyst fixed bed from falling into the product gas compartment.

14. The photoreactor of claim 1, wherein the catalyst fixed bed has a thickness of between 5 mm and 5 cm.

15. The photoreactor of claim 1, wherein the catalyst fixed bed has a thickness that is less than the width of the catalyst fixed bed as disposed on the gas-permeable plate in the photoreactor body.

16. The photoreactor of claim 1, wherein the lighting source has a width substantially similar to a width of the photoreactor body to thereby illuminate substantially the entirety of the width of the photoreactor body in the chamber compartment and the top surface of the catalyst fixed bed.

17. The photoreactor of claim 1, further comprising:
a first thermocouple disposed in an upper portion of the catalyst fixed bed; and
a second thermocouple disposed in a lower portion of the fixed bed,
wherein the first thermocouple and the second thermocouple provide respective first and second temperature measurements indicative a temperature differential between the upper and lower portions of the catalyst fixed bed.

18. The photoreactor of claim 17, wherein the first and second thermocouples pass through respective feedthrough entries disposed in the sidewall of the photoreactor body.

19. The photoreactor of claim 1, wherein during operation, the continuous-flow feed stream of the process gas continuously flows through the inlet into the chamber compartment and reacts, as it passes through the catalyst fixed bed from top to bottom, into a product gas that flows through the perforated plate into the product gas compartment and is discharged via the outlet.

20. The photoreactor of claim 1, wherein the lighting source comprises at least one of (a) an IR lamp or (b) an ARC lamp.

21. The photoreactor of claim 1, wherein the gas-permeable plate comprises a heated metal grid to enhance catalyst performance.

22. The photoreactor of claim 1, wherein the catalyst fixed bed comprises at least one heating element disposed therein.

23. The photoreactor of claim 1, wherein the process gas includes primarily nitrogen (N₂) and hydrogen (H₂) and wherein the product gas includes ammonia (NH₃).

24. The photoreactor of claim 1, wherein the process gas includes primarily ethane and the product gas includes ethylene created via a photocatalytic selective partial dehydrogenation process.

25. The photoreactor of claim 1, wherein the process gas includes primarily propane and the product gas includes propylene created via a photocatalytic selective partial dehydrogenation process.
